(19) United States
(12) Patent Application Publication
(10) Pub. No.: US 2025/0010580 A1
(43) Pub. Date: Jan. 9, 2025

(54) LOW-EMISSIVITY AND ANTI-SOLAR GLAZING

(71) Applicant: AGC GLASS EUROPE, Louvain-la-Neuve (BE)

(72) Inventors: Stijn MAHIEU, Lovendegem (BE); Julie HUBERT, Bruxelles (BE); Anne-Christine BAUDOUIN, Corbais (BE)

(73) Assignee: AGC GLASS EUROPE, Louvain-la-Neuve (BE)

(21) Appl. No.: 18/709,964

(22) PCT Filed: Dec. 5, 2022
(86) PCT No.: PCT/EP2022/084348

§ 371 Date: May 14, 2024

(30) Foreign Application Priority Data
Dec. 16, 2021 (EP) 21215033.8

(51) Int. Cl. B32B 15/04

(52) U.S. Cl. CPC B32B 15/04; B32B 15/043; B32B 2250/05; B32B 2250/42; B32B 2307/412; B32B 2311/08; B32B 2311/20

(57) ABSTRACT

A glazing unit, containing a transparent substrate provided with a stack of thin layers including in an alternating arrangement three infrared radiation reflecting functional layers and four dielectric coatings. The three infrared radiation reflecting functional layers are referred to starting from a surface of the transparent substrate as a first functional layer Ag1, a second functional layer Ag2, and a third functional layer Ag3, and the four dielectric coatings are referred to starting from the surface of the transparent substrate as D1, D2, D3 and D4. Each of the three infrared radiation reflecting functional layers is surrounded by the dielectric coatings and the three infrared radiation reflecting functional layers contain silver.

### TECHNICAL FIELD

The present invention relates to glazing systems that simultaneously have low-emissivity and anti-solar properties and that have low visible reflectance and in particular a low solar factor. These glazings can be incorporated into windows of buildings or used in the field of automotive glazing.

### BACKGROUND ART

Such glazing systems are commonly formed from a transparent substrate of such as a glass sheet covered with a system of thin layers comprising at least two functional layers based on an infrared radiation reflecting material and at least three dielectric coatings, wherein each functional layer is surrounded by dielectric coatings. The functional layers are generally layers of silver with a thickness of some nanometers. With respect to the dielectric layers, they are transparent and traditionally made from metal or silicon oxides and/or nitrides. These different layers are deposited, for example, by means of vacuum deposition techniques such as magnetic field-assisted cathodic sputtering, more commonly referred to as “magnetron sputtering”.

These glazing systems have anti-solar properties that may reduce the risk of excessive overheating, for example, in an enclosed space with large glazed surfaces and thus reduce the power load to be taken into account for air-conditioning in summer. In this case the glazing must allow the least possible amount of total solar energy radiation to pass through, i.e. it must have the lowest possible solar factor (SF or g). However, it is highly desirable that it guarantees a certain level of light transmission (LT) in order to provide a sufficient level of illumination inside the building. These somewhat conflicting requirements express the wish to obtain a glazing unit with a high selectivity (S) defined by the ratio of light transmission to solar factor. These glazing systems also have a low emissivity, which allows a reduction in the heat loss through high wavelength infrared radiation. Thus, they improve the thermal insulation of large glazed surfaces and reduce energy losses and heating costs in cold periods.

These glazing systems are generally assembled as multiple glazing units such as double or triple glazing units or even as laminated glazing units, in which the glass sheet bearing the laminated unit is combined with one or more other glass sheets with or without coating, with the low-emissivity multilayer stack being in contact with the internal space between the glass sheets in the case of multiple glazing units, or in contact with the interlayer adhesive of the laminated unit in the case of laminated glazing units.

In some cases an operation to mechanically reinforce the glazing, such as thermal toughening of the glass sheet or sheets, becomes necessary to improve the resistance to mechanical stresses. For particular applications, it may also become necessary to give the glass sheets a more or less complex curvature by means of a bending operation at high temperature. In the processes of production and shaping of glazing systems there are certain advantages to conducting these heat treatment operations on the already coated substrate instead of coating an already treated substrate. These operations are conducted at a relatively high temperature, which is the temperature at which the functional layer based on infrared reflective material, e.g. based on silver, tends to deteriorate and lose its optical properties and properties relating to infrared radiation. These heat treatments consist in particular of heating the glass sheet to a temperature higher than 560° C. in air, e.g. between 560° C. and 700° C., and in particular around 640° C. to 670° C., for a period of about 3, 4, 6, 8, 10, 12 or even 15 minutes, depending on the type of treatment and the thickness of the sheet. In the case of a bending treatment, the glass sheet may then be bent to the desired shape. The toughening treatment then consists of abruptly cooling the surface of the flat or bent glass sheet by air jets or cooling fluid to obtain a mechanical reinforcement of the sheet.

Therefore, in the case where the coated glass sheet must undergo a heat treatment, quite specific precautions must be taken to form a coating structure that is able to withstand a thermal toughening and/or bending treatment, sometimes referred to hereafter by the term “temperable”, without losing the optical and/or energy properties it has been created for. In particular, the dielectric materials used to form the dielectric coatings must withstand the high temperatures of the heat treatment without exhibiting any adverse structural modification. Examples of materials particularly suitable for this use are zinc-tin mixed oxide, silicon nitride and aluminum nitride. It is also necessary to ensure that the functional layers, e.g. silver-based layers, are not oxidized during the course of the treatment, e.g. by assuring that at the instant of treatment there are barrier layers that are capable of either oxidizing in place of the silver by trapping free oxygen or blocking the free oxygen migrating towards the silver during the heat treatment.

In addition, the formation of these layer assemblies must also result in satisfactory colors both in reflection and transmission with demand tending towards the most complete neutrality possible. The difficulty is to combine the colorimetric requirements with those associated with “base” conditions: high light transmission, very low emissivity, ability to withstand heat treatment, all at the same time.

Another requirement that must be increasingly taken into account results from the fact that products that have not been heat treated and others that have been heat treated must sometimes be combined with one another for the same application, e.g. within the same building facade.

Moreover, while the principles ruling the optical properties of materials forming the layers are well known, an additional difficulty lies in the production methods of these glazing units. The deposition conditions and in particular the deposition rate are dependent on the nature of the materials considered. The deposition rate must be sufficient for economically acceptable industrial production. It depends on multiple factors that guarantee stability of function over time and over the whole surface of the sheet and the absence of defects in the layer.

Several solutions have been proposed to meet these diverse requirements. In particular coating stacks of three silver-based functional layers have been shown to reach very good anti-solar properties. However, no solution has provided a really satisfactory glazing unit that will allow us to comply with the requirements of these new demands.

WO2011020974A1 describes coating stacks of three silver-based functional layers of the type glass/dielectric/Ag/dielectric/Ag/dielectric/Ag/dielectric III, in which each dielectric comprises a silicon nitride layer gives us to understand that the coating stacks that it describes can be heat treated and that they only exhibit slight variations in their optical properties after heat treatment. While silicon nitride layers are beneficial, skipping the first nitride layer is an opportunity to reduce the number of coat zones, as nitrides have to be deposited separate from oxides, without compromising durability of the coating.

### SUMMARY OF INVENTION

It is an object of the present invention to develop a new type of stack of thin low-emissivity and anti-solar layers that is effective in terms of optical and energy properties, and in particular has a low level of reflectance, and that retains these performance levels if then subjected to a toughening or bending type of heat treatment or not.

The following information is used in the present invention:
a. light transmission (LT) is the percentage of incident light flux, illuminant D65/2°, transmitted by the glazing.
b. light reflection (LR) is the percentage of incident light flux, illuminant D65/2°, reflected by the glazing. It may be measured on a single glazing from the layer side (LRc) or the substrate side (LRg). It may be measured on the external side of the building or vehicle (LRext) or the internal side of the building or vehicle (LRint), in particular on a multiple glazing unit or a laminated glazing.
c. energy transmission (ET) is the percentage of incident energy radiation transmitted by the glazing calculated in accordance with standard EN410.
d. energy reflection (ER) is the percentage of incident energy radiation reflected by the glazing calculated in accordance with standard EN410. It may be measured on the external side of the building or vehicle (ERext) or the internal side of the building or vehicle (ERint).
e. solar factor (SF or g) is the percentage of incident energy radiation that is directly transmitted by the glazing, on the one hand, and absorbed by this, then radiated in the opposite direction to the energy source in relation to the glazing. It is here calculated in accordance with standard EN410.
f. the U value (coefficient k) and emissivity (s) are calculated in accordance with standards EN673 and ISO 10292.
g. the CIELAB 1976 values (L*a*b*) are used to define the tints. They are measured with illuminant D65/10°.
h. ΔE*=[(L*)²+(a*)²+(b*²)]^{1/2} represents the tint variation during the heat treatment, i.e. the difference between before and after heat treatment colours.
i. the resistance per square (R2) (“sheet resistance”), expressed in ohms per square (Ω/□), measures the electrical resistance of thin films.

When values are referred to as “in the range of between a and b”, they may be equal to a or b.

The positioning of the stack of layers in a multiple glazing structure is given according to the classic sequential numbering of the faces of a glazing unit, face 1 being on the exterior of the building or vehicle and face 4 (in the case of a double glazing unit) or face 6 (in the case of a triple glazing unit) on the interior.

When referring to silicon nitride or silicon oxide layers herein, it should be understood that the layers may also incorporate a small quantity of aluminum, as is well-known in the art of magnetron sputtered coatings. Such aluminum is included as doping agent, generally in a quantity of 10 Wt.% at most.

For the sake of clarity, when using terms like “below”, “above”, “lower”, “upper”, “first” or “last” herein, it is always in the context of a sequence of layers starting from the glass below, going upward, further away from the glass. Such sequences may comprise additional intermediate layers, in between the defined layers, except when a direct contact is specified.

The present invention relates to a glazing unit according to claim 1 and the dependent claims present preferred embodiments.

The invention concerns a glazing unit comprising a transparent substrate provided with a stack of thin layers comprising an alternating arrangement of 3 infrared radiation reflecting functional layers and 4 dielectric coatings, such that each functional layer is surrounded by dielectric coatings. Indeed, the present invention relates solely to coating stacks comprising three functional silver-based metal layers referred to starting from the substrate surface as first functional layer Ag1, second functional layer Ag2 and third functional layer Ag3, and four dielectric coatings, referred to starting from the substrate surface as D1, D2, D3 and D4, is characterized in that:
a. D1 is free of silicon nitride comprising layers and comprises a metal oxide comprising bottom layer, in direct contact with the substrate, and a zinc oxide-comprising contact layer C1 (3), directly below and in contact with the overlying first functional layer Ag1,
b. D2 comprises
   1. a zinc oxide-comprising contact layer C2, directly above and in contact with the underlying first functional layer Ag1,
   2. a first layer comprising a mixed oxide of zinc and tin in contact with C2
   3. a first layer comprising silicon nitride inserted in the first layer comprising a mixed oxide of zinc and tin, and
   4. a zinc oxide-comprising contact layer C3, directly below and in contact with the first layer comprising a mixed oxide of zinc oxide and tin oxide and with the overlying second functional layer Ag2, and
c. D3 comprises
   1. a zinc oxide-comprising contact layer C4, directly above and in contact with the underlying second functional layer Ag2,
   2. a second layer comprising a mixed oxide of zinc and tin in contact with C4
   3. a second layer comprising silicon nitride inserted in a second layer comprising a mixed oxide of zinc and tin,
   4. a zinc oxide-comprising contact layer C5, directly below and in contact with the overlying third functional layer Ag3, and
d. D4 comprises
   1. a zinc oxide-comprising contact layer C6, directly above and in contact with the underlying third functional layer Ag3,
   2. a third layer comprising a mixed oxide of zinc and tin in contact with C6
   3. a third layer comprising silicon nitride, in contact with the third layer comprising a mixed oxide of zinc and tin, and
   4. a toplayer comprising a metal oxide or a metal nitride, further characterized in that the ratio of the sum of the thicknesses of the layers comprising mixed oxides of zinc and tin over the thickness of the layer of silicon nitride decreases from D2 to D3 to D4 and in that the sum of the thicknesses of D1, D2, D3 and D4 is not more than 225 nm.

The first silicon nitride comprising layer SiN1 is inserted in the first layer comprising a mixed oxide layer of zinc and tin ZSO1, meaning that ZSO1 is separated in two parts. A part of ZSO1 is below and in contact with SiN1 and that another part of ZSO1 is above and in contact with SiN1. In other words, the first silicon nitride comprising layer is in between two sublayers of the first layer comprising a mixed oxide of zinc and tin, a lower sublayer ZSO1a and an upper sublayer ZSO1b.

The second silicon nitride comprising layer SiN2 is inserted in the second layer comprising a mixed oxide layer of zinc and tin ZSO2, meaning that ZSO2 is separated in two parts. A part of ZSO2 is below and in contact with SiN2 and that another part of ZSO2 is above and in contact with SiN2. In other words, the second silicon nitride comprising layer is in between to sublayers of the second layer comprising a mixed oxide of zinc and tin, a lower sublayer ZSO2a and an upper sublayer ZSO2b.

### BRIEF DESCRIPTION OF DRAWINGS

FIG. 1 shows a schematic representation of a a transparent substrate provided with a stack of thin layers according to an embodiment of the present invention.

FIG. 2 shows another schematic representation of a transparent substrate provided with a stack of thin layers according to an embodiment of the present invention.

FIG. 3 shows a schematic representation of a transparent substrate provided with a stack of thin layers according to an embodiment of the present invention.

FIG. 4 shows refractive indices of chosen thin film materials.

Because of the particular selection of layers of the coating stack and in particular because of the ratio of the sum of the thicknesses of the layers comprising mixed oxides of zinc and tin over the thickness of the layer of silicon nitride that decreases from D2 to D3 to D4 a layer stack is obtained that shows on a substrate of normal clear soda lime glass of 6 mm any of the following:
a. Low visible light reflectance, both for LRc and LRg, with LRc and LRg, independently comprised between 5% and 15%, preferably between 7% and 10%; measured on a single glass pane;
b. High selectivity (ratio of visible light transmittance LT to solar factor SF) of LT/SF 1.99 before tempering, or LT/SF 1.92 after tempering
c. Transmittance of visible light 62% LT≥70%; preferably 65% LT≥68%; measured on a single glass pane; In alternate embodiments, 52% LT 60%; preferably 55% LT≥58%; measured on a single glass pane;
d. Color values L*, a*, b*, in transmittance 80≤L*≤90, −12≤a*≤−2, −2≤b*≤8, preferably 84≤L*≤86, −8≤a*≤−6, 2≤b*≤4;
e. Color values L*, a*, b*, in reflection on the glass side (opposite the coated side) 30≤L*≤42, −7≤a*≤3, −18≤b*≤−8, preferably 36≤L*≤38, −3 a*≤−1, —14≤b*≤−12;
f. a low emissivity (ε≤0.038, preferably ε≤0.025) to limit heat losses;
g. a low solar factor SF, with SF<35%, preferably SF≤533%, to enable reduction of the risk of excess overheating as a result of sunshine;
h. the possibility of being heat treated, the coating being resistant to high temperatures, or of being used without heat treatment;
i. an aesthetic appearance without flaw, with an extremely limited or even non-existent haze without or after heat treatment, and the absence of unacceptable spots after heat treatment;
j. the retention of optical and energy properties virtually unchanged after heat treatment allowing the use of products that have been heat treated or not one beside the other (“self-matchability”): no or little change in colour in transmission and in reflection (ΔE*≤8, preferably ≤5, more preferably ≤2) and/or no or little change in light transmission and reflection and energy values (Δ=|(value before heat treatment)−(value after heat treatment)|≤7, preferably ≤6), measured in a single glazing configuration.
k. an adequate chemical stability for use without heat treatment or for the time interval before heat treatment, and in particular a result of the climatic chamber test or the salt spray test according to standard EN1036-2012 that does not give any defect or any discoloration visible to the naked eye after 1 day, preferably after 3 days.

Glazing units may thus provide any of the following advantages (coating on a standard 6 mm thick clear soda-lime float glass sheet incorporated into a double glazing unit with another standard 4 mm thick clear soda-lime float glass sheet, space between glass sheets of 15 mm filled to 90% with argon, stack of layers in position 2):
a. a low solar factor SF, with SF<30%, preferably SF≤28%, to enable reduction of the risk of excess overheating as a result of sunshine;
b. an insulating property enabling a value U≤1.1 W/(m²K), preferably U≤1.0 W/(m²K) to be reached; in a double glazing unit;
c. a neutrality of tint in transmission and in reflection, whether in a single glazing or multiple glazing, with preferred values in single glazing:
   1. in transmission: 76≤L*≤86, −12≤a*≤−2, −2≤b*≤8, preferably 80≤L*≤82, −8≤a*≤−6, 2≤b*≤4
   2. in reflection substrate side of the coated substrate: 38≤L*≤48, −8≤a*≤2, −15≤b*≤−5, preferably 42≤L*≤44, −4≤a*≤−2, −11≤b*≤−9

The inventors among others found that not only was it beneficial to have a metal oxide comprising bottom layer (and not, as in many known coating stacks, a nitride such as aluminium or silicon nitride) in direct contact with the substrate in particular to assure the chemical stability of the product that has not been heat treated or heat treated yet.

### DESCRIPTION OF EMBODIMENTS

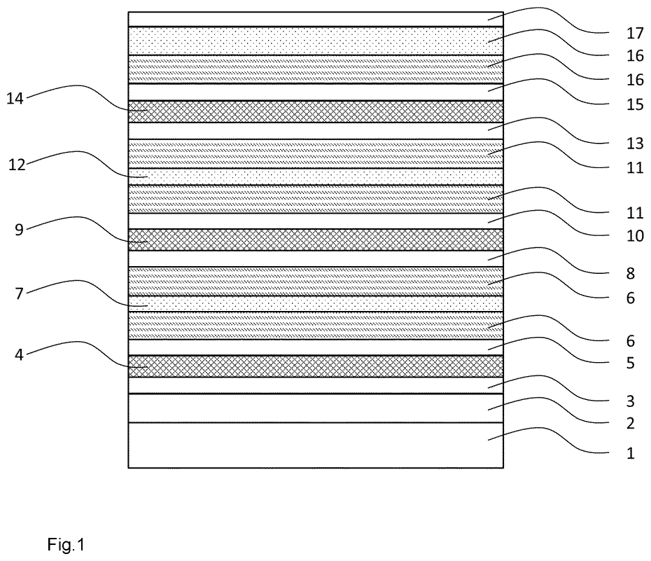

FIG. 1 shows a transparent substrate (1). A metal oxide comprising bottom layer (2), in direct contact with the substrate (1), and a zinc oxide-comprising contact layer C1 (3) (3), directly below and in contact with the overlying first functional layer Ag1 (4). A zinc oxide-comprising contact layer C2 (5), directly above and in contact with the underlying first functional layer Ag1 (4), a first layer comprising a mixed oxide of zinc ZSO1 (6) and is above and in contact with C2 (5). A first layer comprising silicon nitride SiN1 (7) is inserted in the first layer comprising a mixed oxide of zinc and tin ZSO1 (6), and a zinc oxide-comprising contact layer C3 (8), directly below and in contact with the first layer comprising a mixed oxide of zinc oxide and tin oxide ZSO1 (6) and with the overlying second functional layer Ag2 (9). A zinc oxide-comprising contact layer C4 (10), is directly above and in contact with the underlying second functional layer Ag2 (9), a second layer comprising a mixed oxide of zinc and tin ZSO2 (11) is above and in contact with C4 (10) and a second layer comprising silicon nitride SiN2 (12) inserted in a second layer comprising a mixed oxide of zinc and tin ZSO2 (11); A zinc oxide-comprising contact layer C5 (13), directly below and in contact with the overlying third functional layer Ag3 (14), and a zinc oxide-comprising contact layer C6 (15), directly above and in contact with the underlying third functional layer Ag3 (14). A third layer comprising a mixed oxide of zinc and tin ZSO3 (16) is above and in contact with C6 (15) and a third layer comprising silicon nitride SiN3 (17), is above and in contact with the third layer comprising a mixed oxide of zinc and tin ZSO3 (16). A toplayer comprising a metal oxide or a metal nitride TL (18) is above and in contact with the third layer comprising silicon nitride SiN3 (17).

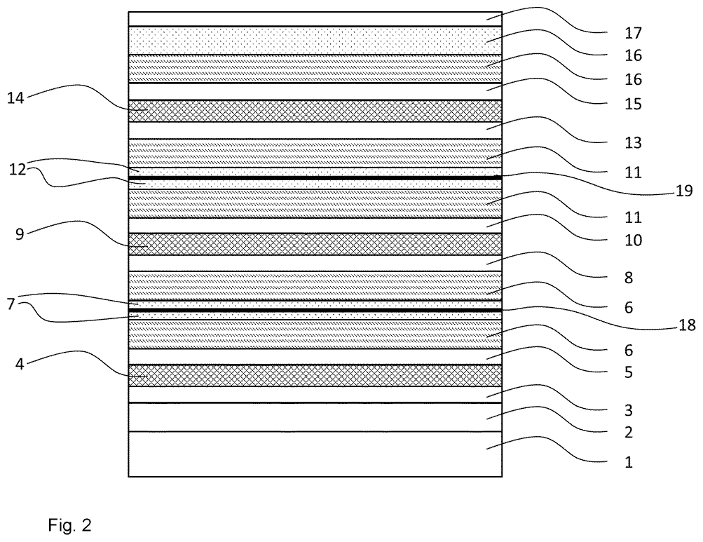

FIG. 2 shows, in addition to the layers depicted in FIG. 1, the optional layers of absorbing material ABS1 (18) and ABS2 (19) inserted respectively in layers SiN1 (7) and SiN2 (12).

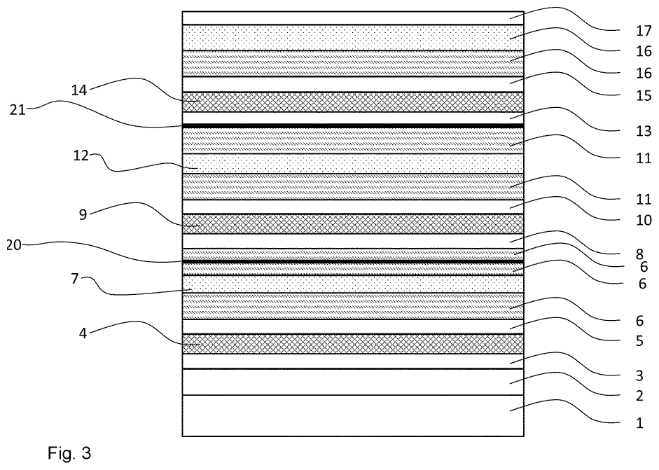

FIG. 3 shows, in addition to the layers depicted in FIG. 1, the optional interlayers IL1 (20) and IL2 (21); IL1 (20) is shown inserted in ZSO1 (6), above and not in contact with SiN (7). IL2 (21) is shown above and in contact with ZSO2 (11).

According to an embodiment of the present invention, one, two or three of the functional layers Ag1, Ag2, Ag3 comprise or essentially consist of silver.

According to an embodiment of the present invention, one, two or three of the functional layers Ag1, Ag2, Ag3 comprise or essentially consist of silver doped with palladium.

According to an embodiment of the present invention the transparent substrate is made of glass. The glass matrix composition is not particularly limited and may thus belongs to different glass categories. The glass may be a soda-lime-silicate glass, an alumino-silicate glass, an alkali-free glass, a boro-silicate glass, etc. Preferably, the glass sheet of the invention is made of a soda-lime glass or a boro-silicate glass.

According to an advantageous embodiment of the invention, combinable with previous embodiments, the glass sheet has a composition comprising a total iron (expressed in terms of Fe₂O₃) content ranging from 0.002 to 0.06 weight %. A total iron (expressed in the form of Fe₂O₃) content of less than or equal to 0.06 weight % makes it possible to obtain a glass sheet with almost no visible coloration. Preferably, the composition comprises a total iron (expressed in the form of Fe₂O₃) content ranging from 0.002 to 0.04 weight %. More preferably, the composition comprises a total iron (expressed in the form of Fe₂O₃) content ranging from 0.002 to 0.02 weight %. In the most preferred embodiment, the composition comprises a total iron (expressed in the form of Fe₂O₃) content ranging from 0.002 to 0.015 weight %.

According to a preferred embodiment, the transparent substrate of the invention is a float glass sheet. The transparent substrate, for example glass sheet, according to the invention may have a thickness of from 0.1 to 25 mm.

According to an embodiment of the present invention, the stack of thin layers of the present invention, a layer of absorbing material to absorb solar radiation that may be inserted in the first and/or second layer comprising silicon nitride. In particular a layer of absorbing material ABS1 may be inserted in the first layer comprising silicon nitride SiN1 and/or a layer of absorbing material ABS2 may be inserted in the second layer comprising silicon nitride SiN2, meaning a lower part of the respective silicon nitride comprising layer is below and in contact with the respective layer of absorbing material and an upper part of the respective silicon nitride comprising layer is above and in contact with the respective layer of absorbing material. In other words, the layer of absorbing material ABS1 is in between and in contact with two sublayers of the first silicon nitride comprising layer SiN1, a lower sublayer SiN1a and an upper sublayer SiN1b. Similarly, the layer of absorbing material ABS2 is in between and in contact with two sublayers of the second silicon nitride comprising layer, a lower sublayer SiN2a and an upper sublayer SiN2b.

The layers of absorbing material help lower the visible light transmittance of the layer stack. Inserting absorbing layers in between silicon nitride layers prevents them from being oxidized during deposition of subsequent layers and during tempering. Advantageously, a layer of absorbing material ABS1 inserted in the first layer comprising silicon nitride SiN1 leads to lower reflectance values inside a building than a similar layer of absorbing material ABS2 inserted in the second layer comprising silicon nitride SiN2. This is evaluated on a double glazing unit with another standard 4 mm thick clear soda-lime float glass sheet, space between glass sheets of 15 mm filled to 90% with argon, stack of layers in position 2.

According to an embodiment of the present invention, the layers of absorbing material may in particular comprise or consist of an alloy of Ni and Cr, or an alloy of Ni, Cr and W.

The absorbing material may consist of an alloy of Ni, Cr and W and comprise from 30% to 90%, preferably from 40% to 70% and advantageously from 45% to 65% by weight of tungsten, and nickel and chromium in a nickel/chromium weight ratio of between 100/0 and 50/50, preferentially 80/20.

The absorbing material may consist of an alloy of Ni and Cr in a Ni/Cr weight ratio of between 99/1 and 50/50, preferentially 80/20.

The layers of comprising absorbing material ABS 1 and ABS2 may have a combined geometrical thickness of at least 0.3 nm. In particular the combined geometrical thickness of ABS1 and ABS2 may at most 3 nm.

Preferably a layer of absorbing material is inserted only in the first layer comprising silicon nitride. This leads to lower visible light reflectance values than if the layer is inserted in the second layer comprising silicon nitride.

According to an embodiment of the present invention D2 and/or D3 may comprise an interlayer, above and not in direct contact with the respective silicon nitride comprising layers SiN1 and SiN2 of D2 and D3, for increasing the chemical and/or mechanical resistance of the stack of thin layers. The interlayer material comprises a metal oxide or mixed metal oxide, free of zinc and tin.
a. In D2 first interlayer IL1 may be
   1. either inserted in between and in contact with contact layer C3 and the first layer comprising a mixed oxide of zinc and tin ZSO1,
   2. or inserted in the first layer comprising a mixed oxide of zinc and tin ZSO1. This means the sublayer ZSO1b is separated in two parts. A part of ZSO1b is below and in contact with IL1 and that another part of ZSO1b is above and in contact with IL1. In other words, IL1 is in between to sublayers of ZSO1b, a lower sublayer ZSO1ba and an upper sublayer ZSO1bb.
b. In D3 second interlayer IL2 may be
   1. either inserted in between and in contact with contact layer C5 and the second layer comprising a mixed oxide of zinc and tin ZSO2,
   2. or inserted in the second layer comprising a mixed oxide of zinc and tin ZSO2. This means the sublayer ZSO2b is separated in two parts. A part of ZSO2b is below and in contact with IL2 and that another part of ZSO2b is above and in contact with IL2. In other words, IL2 is in between to sublayers of ZSO2b, a lower sublayer ZSO2ba and an upper sublayer ZSO2bb.

The inventors found that these interlayers may further increase the chemical and/or mechanical durability of the layer stacks.

The material of any interlayer may in particular comprise titanium oxide, a mixed oxide of titanium and zirconium, a mixed oxide of nickel and chromium or a mixed oxide of nickel chromium an tungsten.

The material of any interlayer may in particular comprise a mixed oxide of titanium and zirconium with a weight ratio TiO2/ZrO2 from 55/45 to 75/25, preferably from 60/40 to 70/30

The interlayers IL1 and IL2 may each have a geometrical thickness from 1 to 5 nm, preferably from 1 to 3 nm.

It is noted that the invention relates to all possible combinations of features recited in the claims.

The individual layers of the stack of layers of the present invention are preferably deposited by magnetron sputtering. Metal or metal alloy layers are typically deposited in an inert gas atmosphere from metal or metal alloy sputtering targets. Oxide layers are typically deposited from a metal, metal alloy or silicon target in an atmosphere comprising oxygen, usually mixed with an inert gas such as argon or krypton for example. Alternately oxide layers may deposited from ceramic oxide targets in an inert gas atmosphere, possibly containing oxygen. Nitride layers are typically deposited from metal, metal alloy or silicon sputtering targets in nitrogen comprising atmospheres, usually mixed with an inert gas such as argon or krypton for example.

The material of the zinc oxide-comprising contact layers C1 to C6, underlying or overlying any functional layers in the stack of layers of the present invention, may be chosen independently among any of the following:
a. a zinc oxide doped with aluminium in a weight ratio of Zn/Al of at least 95/5, preferably at least 98/2;
b. pure ZnO (designated as iZnO);
c. zinc oxide doped with aluminium (designated as AZO) in a proportion of up to 10% by weight, alternately of up to 5% by weight at most, preferably of around 2% by weight.

These types of contact layers have the advantage of reducing the changes in opto-energetical properties, in particular color and transmittance, upon heat treatment. Metal based contact layers in particular show higher degrees of change in opto-energetical properties upon heat treatment and also need careful control of the deposition of overlying oxide and nitride layers as these lead to differing degrees of oxidation/nitration of any underlying metal layers. These zinc oxide based contact layers furthermore lead to more controlled growth of overlying functional layers, thereby lower functional layer thicknesses are required to reach desired degrees of emissivity.

The contact layers may be obtained by sputtering from a metal target of silicon, optionally doped with aluminum, in an oxygen containing atmosphere. Alternately the contact layers may be obtained by sputtering a ceramic target of aluminum doped zinc oxide in a non-oxidizing atmosphere. This is preferred when depositing a contact layer on a silver layer.

According to an embodiment of the present invention, the thickness of the contact layers comprising zinc oxide is preferably 10 nm at most, more preferably 8 nm at most even more preferably 6 nm at most.

According to an embodiment of the present invention, the thickness of the contact layers comprising zinc oxide is preferably at least 2 nm, more preferably at least 3 nm.

According to an embodiment of the present invention, the sum of the thicknesses of D1, D2, D3 and D4 is not more than 220 nm, preferably not more than 215 nm, more preferably not more than 212 nm.

According to an embodiment of the present invention, the sum of the thicknesses of D1, D2, D3 and D4 is at least 150 nm, preferably at least 170 nm, more preferably at least 180 nm.

According to an embodiment of the present invention the thickness of D1 is comprised between 30 and 50 nm.

According to an embodiment of the present invention the thickness of D2 is comprised between 65 and 85 nm, preferably between 70 and 80 nm.

According to an embodiment of the present invention the thickness of D3 is comprised between 50 and 70 nm, preferably between 55 and 65 nm.

According to an embodiment of the present invention the thickness of D4 is comprised between 25 and 45 nm, preferably between 30 and 40 nm, more preferably between 32 and 40 nm.

Preferably the thickness of D2 is larger than the thickness of D1, D3, and D4.

Preferably the thickness of D3 is larger than the thickness of D1 and D4.

Preferably the ratio of the thickness of D1 to the thickness of D4 is comprised between 0.8 and 1.4.

According to an embodiment of the present invention the According to an embodiment of the present invention the thicknesses of Ag1, Ag2 and Ag3 are each comprised between 10 and 16 nm.

According to an advantageous embodiment of the present invention the thickness of Ag1 is comprised between 12 and 18 nm, more advantageously between 13 and 14 nm.

According to an advantageous embodiment of the present invention the thickness of Ag2 is comprised between 10 and 17 nm. The thickness of Ag2 may be comprised between 12 and 17 nm, between 12 and 16 nm, or between 14 and 16 nm, Alternately between 10 and 15 nm, more advantageously between 11 and 13 nm.

According to an advantageous embodiment of the present invention the thickness of Ag3 is comprised between 11 and 18 nm, advantageously between 12 and 17 nm, more advantageously between 13 and 15.5 nm.

Advantageously, the ratio of the thickness of Ag1 to the thickness of Ag3 is comprised between 0.8 and 1.2.

Advantageously, the thickness of Ag2 is lower than the thickness of Ag1 and Ag3.

D1 comprises a bottom layer BL comprising a metal oxide, in direct contact with the substrate, and a zinc oxide-comprising contact layer C1, directly below and in contact with the overlying functional layer. Advantageously, the bottom layer BL is in direct contact with the zinc oxide comprising contact layer C1.

In an advantageous embodiment of the present invention, the metal oxide comprising bottom layer BL in D1, is a layer of an oxide of at least one element selected from Zn, Sn, Ti and Zr.

In an preferred embodiment of the present invention, BL is preferably a layer of zinc-tin mixed oxide, more preferably a layer of zinc-tin mixed oxide, in which the proportion of zinc-in is close to 50-50% by weight (Zn₂SnO₄), e.g. 52-48 Wt.%. The zinc-tin mixed oxide may be advantageous in that it has a good deposition rate compared, for example, to SiO₂ or Al₂O₃, and/or in that it has a good stability compared, for example, to pure ZnO or bismuth oxide. Moreover, it may be advantageous in that it has less tendency to generate haze after heat treatment of the stack compared, for example, to the oxides of Ti or Zr.

In an advantageous embodiment of the present invention, BL has a thickness of at least 15 nm, preferably at least 20 nm. These minimum thickness values allow, inter alia, the chemical stability of the product that has not been heat treated to be assured, as well as assuring the resistance to the heat treatment.

According to a preferred embodiment of the present invention, BL has a thickness of at least 30 nm, more preferably at least 35 nm. Furthermore, its thickness may preferably be 50 nm at most, more preferably 40 nm at most.

As uppermost layer of D1, the zinc oxide-comprising contact layer C1, directly under and in contact with the functional layer Ag1, is sometimes referred to as a “nucleation” or “wetting” layer, which assists the growth of the silver on top of it and helps increase the resistance per square of the product.

In an embodiment of the present invention, this zinc oxide-based layer C1 consists of zinc oxide or alternately doped with other metals, e.g. aluminium, in a proportion generally of 10% by weight at most, preferably around 2% by weight.

In an embodiment of the present invention, C1 has a thickness of 15 nm at most, preferably in the range of between 1.5 and 10 nm, more preferably between 3 and 10 nm.

D1 is free of silicon nitride.

In D2, D3, and D4, any one of the first, second and third silicon nitride comprising layers is not necessarily stoichiometric and may comprise other elements. The silicon nitride comprising layers in the present invention's layer stack may prevent in particular oxygen from migrating through the layer stack towards the functional layers, in particular upon heat treatment.

In an embodiment of the present invention, these silicon nitride comprising layer is chosen among Si₃N₄, SiₓN_{y}, wherein the atomic ratio Si/N ranges from 0.6 to 0.9, preferably from 0.7 to 0.8, and a mixed nitride of silicon and zirconium, with a weight ratio of Si/Zr ranging between 70/30 and 50/50, preferably ranging between 65/35 and 55/45.

In a preferred embodiment of the present invention, in D2, D3, and D4, any one of the first, second and third silicon nitride comprising layers is preferably close to stoichiometric Si₃N₄, that is it comprises silicon and nitrogen in an atomic ratio Si/N of at least 0.72 and at most 0.78, preferably the atomic ratio Si/N is at least 0.74 and at most 0.76. This provides for low visible adsorption and additionally reduces the amount of color change upon heat treatment compared to SiₓN_{y} which is further away from stoichiometry.

According to an embodiment of the present invention the thickness of the silicon nitride comprising layers is at least 15 nm, advantageously at least 20 nm. Such minimum thicknesses may be necessary to provide these layers' beneficial effects.

According to an embodiment of the present invention, the thickness of the any of the silicon nitride comprising layers is at most 40 nm, advantageously at most 35 nm. Such thicknesses may be necessary to limit intrinsic stress within these layers which may lead to a degradation of mechanical and/or chemical durability in particular as there are three silicon nitride comprising layers present in the layer stack.

In an embodiment of the present invention, in D2, D3, and D4, any one of the first, second, and third layers comprising a mixed oxide of zinc and tin, comprises a mixed oxide of zinc and tin is wherein the weight ratio of zinc to tin, Zn/Sn, ranges from 1/9 to 9/1. Advantageously the proportion of zinc-tin is close to 50-50% by weight, e.g. 52-48 Wt.% and for example consist of Zn₂SnO₄.

According to an embodiment of the present invention, in D2, D3, and D4, any one or more of the first, second, and third layers comprising a mixed oxide of zinc and tin has a thickness of at least 10 nm, more preferably at least 20 nm. Its thickness is preferably 50 nm at most, more preferably 45 nm at most.

According to a preferred embodiment of the present invention, in D2, the first layer comprising a mixed oxide of zinc and tin ZSO1 has a thickness of at least 20 nm, more preferably at least 25 nm. Furthermore, its thickness may be 55 nm at most, preferably be 50 nm at most, alternately 45 nm at most.

According to a preferred embodiment of the present invention, in D3, the second layer comprising a mixed oxide of zinc and tin ZSO2 has a thickness of at least 10 nm, more preferably at least 15 nm. Furthermore, its thickness may preferably be 45 nm at most, preferably 40 nm at most.

According to a preferred embodiment of the present invention, in D4, the third layer comprising a mixed oxide of zinc and tin ZSO3 has a thickness of at least 1 nm, more preferably at least 3 nm. Furthermore, its thickness may preferably be 12 nm at most, more preferably 10 nm at most, even more preferably 8 nm at most.

According to a preferred embodiment of the present invention, in D2 the first silicon nitride layer SiN1 is inserted in the first layer comprising a mixed oxide of zinc and tin ZSO1 so that at least 10 nm of the respective mixed oxide layer is below and at least 10 nm of the mixed oxide layer is above the nitride layer.

According to a preferred embodiment of the present invention, in D3 the second silicon nitride layer SiN2 is inserted in the second layer comprising a mixed oxide of zinc and tin ZSO2 so that at least 10 nm of the respective mixed oxide layer is below and at least 10 nm of the mixed oxide layer is above the nitride layer.

While tin zinc oxide is interesting for its high deposition rates, inserting the silicon nitride comprising layers in zinc tin oxide comprising layers creates an alternation of layers that limits the thickness of each layer or sub-layer. The inventors believe that this may contribute to interrupting defects occurring during the growth of a layer on one hand and/or may limit the build-up of thickness dependent intrinsic stress as layers get thicker. It furthermore reduces the overall amount of oxygen in the layer stack. Thus reducing the risk of oxidizing the silver layers, in particular during heat treatments such as tempering. Limiting the sum of the thicknesses of D1, D2, D3 and D4 further reduces the overall amount of oxygen in the layer stack. This alternation of layers and limitation of dieletric thicknesses gives an overall more durable layer stack.

Furthermore it was surprisingly found that limiting the sum of dielectrics' thicknesses allowed for the solar factor to be further reduced while visible light transmittance was kept high, thus increasing selectivity.

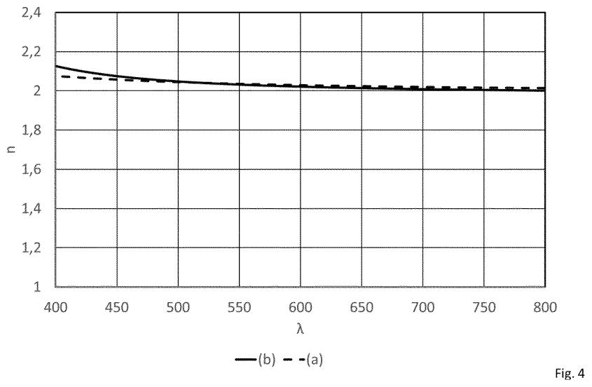

It is an additional advantage, that the refractive index in the visible wavelength range is very similar for silicon nitride comprising layers and zinc tin oxide layers of the layer stack of the present invention. This can be seen in FIG. 4, illustrating the refractive index n vs the wavelength λ[nm] for the thin film materials Si₃N₄(a) and Zn₂SnO₄ (b). Therefore deviations of layer stack thicknesses in one layer may be compensated by adjusting the thickness of the adjacent layer of different composition without negatively affecting the optical properties of the overall layer stack.

When an interlayer IL1 or IL2 is inserted in at least one of the second or third layers comprising a mixed oxide of zinc and tin, at least 5 nm of the respective mixed oxide layer of zinc and tin is below and at least 5 nm of the mixed oxide layer is above the interlayer.

According to an embodiment of the present invention, in D4 the toplayer comprising a metal oxide or a metal nitride TL is a layer comprising titanium and/or zirconium or a mixed nitride of silicon and zirconium. Such a layer provides in particular mechanical protection to the stack of layers.

According to an embodiment of the present invention, the metal oxide or metal nitride toplayer of D4 is the last layer of the layer stack, the outermost layer. Temporary protective means such as removable plastic films or carbon films may however be provided on this last permanent layer.

In an advantageous embodiment of the present invention, the topcoat comprises at least TiO_{y} and ZrO_{z}, and optionally SiOₓ, wherein x, y, z range from 1.8 to 2.2, wherein the topcoat comprises
a. from 8 to 49 at % titanium,
b. from 51 to 92 at % zirconium,
c. from 0 to 9 at % silicon,
d. for a total of 100 at % of the metals, and wherein the topcoat has a thickness from 0.1 to 10 nm; to improve durability by increasing the abrasion resistance by at least 20%, alternatively by at least 30%, alternatively by at least 40%.

In some embodiments of the present use, compatible with other embodiments of the present invention, the above ranges for the Ti, Zr and Si in the topcoat may independently vary for one from the other. The amount of Ti may alternatively range from 10 to 47 at %, alternatively from 12 to 46 at %. The amount of Zr may alternatively range from 53 to 90 at %. The amount of Si may alternatively range from 1 to 8 at %, alternatively from 2 to 7 at %. These amounts may thus vary independently for each metal, provided the total is 100 at % of the metal, including impurities, as discussed above.

In an advantageous embodiment of the present invention, the metal oxide or metal nitride toplayer of D4 consists of an oxide or substoichiometric oxide of at least one element selected from Ti and Zr, more preferably of a titanium-zirconium mixed oxide, e.g. in a weight ratio of TiO_{y}/ZrO_{z} of close to 65/35. Such a layer may provide particular good chemical and/or mechanical stability of the glazing.

Traces of Yttrium may be present in any Zr containing layers of the present layer stack.

In another advantageous embodiment of the present invention, the metal oxide or metal nitride toplayer of D4 consists of a mixed nitride of silicon and zirconium. Advantageously the mixed nitride of silicon and zirconium having a Si/Zr atomic ratio of at least1 or at least 4. Advantageously the mixed nitride of silicon and zirconium having a Si/Zr atomic ratio of at most 12 or at most 6.

The toplayer in D4 preferably has a geometric thickness of at least 1 nm, preferably at least 1.5 nm. Its geometric thickness is 5 nm at most, advantageously 3 nm at most. Unless otherwise noted, all thicknesses herewithin are geometric thicknesses.

Particular embodiments of the invention will now be described by way of examples.

All thicknesses of the examples are given in nm. All the layers have been deposited using magnetic field-assisted cathodic sputtering under vacuum.

Table 1 shows simplified exemplary layer stacks wherein the inserted silicon nitride layers, SiN1, and SiN2, and interlayers IL1 and IL2 are not represented.

When heat treatment took place, this was conducted in the following conditions: curing in a static oven at 670° C. for 9 min. 30 sec.

TABLE 1
simplified layer stacks

| Glass | | Example 1 | Example 2 |
|---|---|---|---|
| D1 | Bottom layer BL | ZSO5 34-36 nm | ZSO5 34-36 nm |
| | Contact layer C1 (3) | ZnO:Al 3-5 nm | ZnO:Al 3-5 nm |
| Ag1 | 1^{st} functional layer | Ag 13.7 nm | Ag 13.6 nm |
| D2 | Contact layer C2 | ZnO:Al 3-5 nm | ZnO:Al 3-5 nm |
| | 1st mixed oxide of zinc | ZSO5 28-43 nm | ZSO5 28-43 nm |
| | and tin ZSO1 | | |
| | Contact layer C3 | ZnO:Al 3-5 nm | ZnO:Al 3-5 nm |
| Ag2 | 2^{nd} functional layer | Ag 12.1 nm | Ag 12.0 nm |
| D3 | Contact layer C4 | ZnO:Al 3-5 nm | ZnO:Al 3-5 nm |
| | 2^{nd} mixed oxide | ZSO5 16-31 nm | ZSO5 16-31 nm |
| | of zinc and tin ZSO2 | | |
| | Contact layer C5 | ZnO:Al 3-5 nm | ZnO:Al 3-5 nm |
| Ag3 | 3^{rd} functional layer | Ag 14.4 n nm | Ag 13.8 n nm |
| D4 | Contact layer C6 | ZnO:Al 3-5 nm | ZnO:Al 3-5 nm |
| | 3^{rd} mixed oxide | ZSO5 1-8 nm | ZSO5 2-8 nm |
| | of zinc andt in ZSO3 | | |
| | 3^{rd} silicon nitride | SiN 20-25 nm | SiN 20-25 nm |
| | layer SiN3 | | |
| | Toplayer comprising a | TZO 1.5-3 nm | TZO 1.5-3 nm |
| | metal oxide or a metal | | |
| | nitride TL | | |

In Example 1, a layer of silicon nitride SiN1 and an interlayer IL1 of TZO are inserted in the 1 st mixed oxide layer of zinc and tin ZSO 1, leading to the following layer sequence in D2, starting from the Ag1:
ZnO:Al 3-5 nm/ZS05 12-17 nm/SiN 25-35 nm/ZS05 6-8 nm/TZO 1-2 nm/ZSO5 6-8 nm/ZnO:Al 3-5 nm. Herewithin, the character “I” denotes the interface between adjacent layers or sublayers.

In Example 2, a layer of silicon nitride SiN1 and an interlayer IL1 of TZO are inserted in the first mixed oxide layer of zinc and tin ZSO1. Furthermore an absorber layer ABS1 of NiCrW is inserted in the first layer comprising silicon nitride SiN1, leading to the following layer sequence in D2, starting from the Ag1: ZnO:Al 3-5 nm/ZSO5 12-17 nm/SiN 12-18 nm/NiCrWO0.8 nm/SiN 12-18 nm/ZSO5 6-8 nm/TZO 1-2 nm/ZSO5 6-8 nm/ZnO:Al 3-5 nm.

Furthermore, in Examples 1 and 2, a layer of silicon nitride SiN2 is inserted in the 2nd mixed oxide layer of zinc and tin ZSO2, and an interlayer IL2 of TZO between ZSO2 and 05, leading to the following layer sequence in D3, starting from the Ag2: ZnO:Al 3-5 nm/ZSO5 12-17 nm/SiN 25-35 nm/ZSO5 12-1 7 nm/TZO 1-2 nm/ZnO:Al 3-5 nm.

In Table 2 below, SGU denotes a single glazing unit of 6 mm thick clear glass, DGU a double glazing unit. As can be seen opto-energetical properties within the desired ranges are obtained. In particular low reflectance values are obtained. Here double glazing units comprise an outer glass sheet of 6 mm clear glass with the coating in position 2, spaced 15 mm apart from the inner 4 mm clear glass sheet by a cavity filled to 90% with argon. All glass sheets are normal clear soda lime glass sheets.

Glazings according to the invention simultaneously have low-emissivity and anti-solar properties and have low visible reflectance. Example 1 and heat treated example 2 also show good results in climatic chamber tests and neutral salt spray tests in accordance with standard EN 1096-2012, with no or very little degradation for a duration of 1 day, 2 days even up to 3 days. Example 2 shows advantageously lower inside light reflectance, apparently due to the presence of the ABS1 layer.

TABLE 2

| | Example | Example | Example | Example |
|---|---|---|---|---|
| | 1 SGU | 2 SGU | 1 DGU | 2 DGU |
| TL [%] | 68.92 | 65.23 | 62.58 | 59.12 |
| RL Outside [%] | 8.92 | 9.38 | 12.78 | 12.84 |
| RL Inside [%] | 7.32 | 5.10 | 14.05 | 12.22 |
| Solar Factor (FS | 34.76 | 33.99 | 29.95 | 29.14 |
| or g) | | | | |
| Emissivity | 0.018 | 0.016 | 0.018 | 0.016 |
| U value | 3.17 | 3.16 | 1.06 | 1.06 |
| k(W/m2 · C) | | | | |
| Selectivity | 1.98 | 1.92 | 2.09 | 2.03 |
| (TL/FS) | | | | |
| a* TL | −6.26 | −7.22 | −6.58 | −7.33 |
| b* TL | 3.62 | 1.65 | 3.65 | 1.71 |
| a* RL outside | −1.84 | −0.77 | −3.55 | −2.77 |
| b* RL outside | −11.21 | −13.27 | −8.29 | −10.87 |
| a* RL inside | −1.14 | 15.79 | −1.1 | 7.19 |
| b* RL inside | −8.8 | −12.64 | −5.11 | −6.64 |

TABLE 3
further simplified layer stack

| | |
|---|---|
| Glass | Example 3 |

| | | |
|---|---|---|
| D1 | Bottom layer BL | ZSO5 42 nm |
| | Contact layer C1 | ZnO:Al 5.6 nm |
| Ag1 | 1^{st} functional layer | Ag 12.4 nm |
| D2 | Contact layer C2 | ZnO:Al 3 nm |
| | 1st mixed oxide of zinc | ZSO5 38.4 nm |
| | and tin ZSO1 | |
| | Contact layer C3 | ZnO:Al 5 nm |
| Ag2 | 2^{nd} functional layer | Ag 11.8 nm |
| D3 | Contact layer C4 | ZnO:Al 3 nm |
| | 2^{nd} mixed oxide of | ZSO5 22.2 nm |
| | zinc and tin ZSO2 | |
| | Contact layer C5 | ZnO:Al 5 nm |
| Ag3 | 3^{rd} functional layer | Ag 15.4 n nm |
| D4 | Contact layer C6 | ZnO:Al 3 nm |
| | 3^{rd} mixed oxide | ZSO5 5.4 nm |
| | of zinc and tin ZSO3 | |
| | 3^{rd} silicon nitride layer SiN3 | SiN 20 nm |
| | Toplayer comprising a | TZO 3 nm |
| | metal oxide or a metal | |
| | nitride TL | |

In comparative Example 3, a layer of silicon nitride SiN1 is in the 1st mixed oxide layer of zinc and tin ZSO1, leading to the following layer sequence in D2, starting from the Ag1: ZnO:Al 3 nm/ZSO5 21.7 nm/SiN 35 nm/ZSO5 16.7 nm/ZnO:Al 5 nm.

Furthermore, in comparative Examples 3, a layer of silicon nitride SiN2 is inserted in the 2nd mixed oxide layer of zinc and tin ZSO2, leading to the following layer sequence in D3, starting from the Ag2: ZnO:Al 3 nm/ZSO5 13.6 nm/SiN 35 nm/ZSO5 8.6 nm/ZnO:Al 5 nm.

TABLE 4

| | Example 3 SGU | Example 3 DGU |
|---|---|---|
| TL [%] | 68.9 | 62.6 |
| RL Outside [%] | 9.6 | 13.4 |
| RL Inside [%] | 8.6 | 15.1 |
| Solar Factor (FS | 42.1 | 33.3 |
| or g) | | |
| Emissivity | 0.02 | 0.02 |
| U value | 3.17 | 1 |
| k(W/m2 · C) | | |
| Selectivity | 1.64 | 1.88 |
| (TL/FS) | | |
| a* TL | −4.4 | −4.8 |
| b* TL | 1.4 | 1.5 |
| a* RL outside | −2.2 | −3.3 |
| b* RL outside | −9.0 | −7.1 |
| a* RL inside | 7.5 | 3.7 |
| b* RL inside | −5.5 | −3.3 |

Tables 5a and 5b show the exemplary layer stacks in detail. All thicknesses of the layers are given in nm and indicated in parentheses.

TABLE 5a

| | |
|---|---|
| Example 1 | Example 3 |

Glass

| | | | | |
|---|---|---|---|---|
| D1 | BL | | ZSO5 (34-36) | ZSO5 (42) |
| | C1 | | ZnO:Al (3-5) | ZnO:Al (5.6) |
| Ag1 | | | Ag (13.7) | Ag (12.4) |
| D2 | C2 | | ZnO:Al (3-5) | ZnO:Al (3) |
| | ZSO1 | ZSO1a | ZSO5 (12-17) | ZSO5 (21.7) |
| | | SiN1 | SiN (25-35) | SiN (35) |
| | | ZSO1ba | ZSO5 (6-8) | ZSO5 (16.7) |
| | | IL1 | TZO (1-2) | |
| | | ZSO1bb | ZSO5 (6-8) | |
| | C3 | | ZnO:Al (3-5) | ZnO:Al (5) |
| Ag2 | | | Ag (12.1) | Ag (11.8) |
| D3 | C4 | | ZnO:Al (3-5) | ZnO:Al (3) |
| | ZSO2 | ZSO2a | ZSO5 (12-17) | ZSO5 (13.6) |
| | | SiN2 | SiN (25-35) | SiN (35) |
| | | ZSO2b | ZSO5 (12-17) | ZSO5 (8.6) |
| | | IL2 | TZO (1-2) | — |
| | C5 | | ZnO:Al (3-5) | ZnO:Al (5) |
| Ag3 | | | Ag (14.4) | Ag (15.4) |
| D4 | C6 | | ZnO:Al (3-5) | ZnO:Al (3) |
| | ZSO3 | | ZSO5 (1-8) | ZSO5 (5.4) |
| | SiN3 | | SiN (20-25) | SiN (20) |
| | TL | | TZO ( (1.5-3) | TZO (3) |

TABLE 5b

Example 2

Glass

| | | | |
|---|---|---|---|
| D1 | BL | | ZSO5 (34-36) |
| | C1 | | ZnO:Al (3-5) |
| Ag1 | | | Ag (13.6) |
| D2 | C2 | | ZnO:Al (3-5) |
| | ZSO1 | ZSO5 | ZSO5 (12-17) |
| | | SiN1a | SiN (12-18) |
| | | ABS1 | NiCrW (0.8) |
| | | SiN1b | SiN (12-18) |
| | | ZSO1ba | ZSO5 (6-8) |
| | | IL1 | TZO (1-2) |
| | | ZSO1bb | ZSO5 (6-8) |
| | C3 | | ZnO:Al (3-5) |
| Ag2 | | | Ag (12.0) |
| D3 | C4 | | ZnO:Al (3-5) |
| | ZSO2 | ZSO2a | ZSO5 (12-17) |
| | | SiN2 | SiN (25-35) |
| | | ZSO2b | ZSO5 (12-17) |
| | | IL2 | TZO (1-2) |
| | C5 | | ZnO:Al (3-5) |
| Ag3 | | | Ag (13.8) |
| D4 | C6 | | ZnO:Al (3-5) |
| | ZSO3 | | ZSO5 (2-8) |
| | SiN3 | | SiN (20-25) |
| | TL | | TZO (1.5-3) |

It was found that glazings with coating examples 1 and 2, among others by limiting the sum of dielectrics' thicknesses allowed for the solar factor to be lower than in glazings with coating example 3. At the same time transmittance is kept high in example 1 and 2 glazings and thus selectivity is also higher.

1: A glazing unit, comprising:
a transparent substrate provided with a stack of thin layers comprising in an alternating arrangement three infrared radiation reflecting functional layers and four dielectric coatings,
wherein the three infrared radiation reflecting functional layers are referred to starting from a surface of the transparent substrate as a first functional layer Ag1, a second functional layer Ag2 and a third functional layer Ag3,
wherein the four dielectric coatings are referred to starting from the surface of the transparent substrate as D1, D2, D3 and D4,
wherein each of the three infrared radiation reflecting functional layers is surrounded by the dielectric coatings, and
wherein the three infrared radiation reflecting functional layers comprise silver,
wherein D1 is free of silicon nitride comprising layers and comprises a metal oxide comprising bottom layer BL, in direct contact with the transparent substrate, and a zinc oxide-comprising contact layer C1, directly below and in contact with the first functional layer Ag1,
wherein D2 comprises
i. a zinc oxide-comprising contact layer C2, directly above and in contact with the first functional layer Ag1,
ii. a first layer comprising a mixed oxide of zinc and tin ZSO1 in contact with C2,
iii. a first layer comprising silicon nitride SiN1 inserted in the first layer comprising the mixed oxide of zinc and tin ZSO1, and
iv. a zinc oxide-comprising contact layer C3, above the first layer comprising the mixed oxide of zinc and tin ZSO1 and below and in contact with the second functional layer Ag2,
wherein D3 comprises
i. a zinc oxide-comprising contact layer C4, directly above and in contact with the second functional layer Ag2,
ii. a second layer comprising a mixed oxide of zinc and tin ZSO2 in contact with C4,
iii. a second layer comprising silicon nitride SiN2 inserted in the second layer comprising the mixed oxide of zinc and tin ZSO2, and
iv. a zinc oxide-comprising contact layer C5, directly below and in contact with the third functional layer Ag3,
wherein D4 comprises
i. a zinc oxide-comprising contact layer C6, directly above and in contact with the third functional layer Ag3,
ii. a third layer comprising a mixed oxide of zinc and tin in contact with C6,
iii. a third layer comprising silicon nitride, in contact with the third layer comprising the mixed oxide of zinc and tin, and
iv. a top layer comprising a metal oxide or a metal nitride,
wherein a ratio of a sum of thicknesses of the first, second, and third layers comprising the mixed oxide of zinc and tin to a sum of thicknesses of the first, second, and third layers comprising the silicon nitride decreases from D2 to D3 to D4, and
wherein a sum of thicknesses of D1, D2, D3 and D4 is not more than 225 nm.

2: The glazing unit according to claim 1, wherein the stack of thin layers further comprises a layer of absorbing material ABS1 inserted in the first layer comprising silicon nitride SiN1 and/or a layer of absorbing material ABS2 inserted in the second layer comprising silicon nitride SiN2.

3: The glazing unit according to claim 2, wherein the layers of absorbing material comprise an alloy of Ni and Cr, or an alloy of Ni, Cr and W.

4: The glazing unit according to claim 1, any wherein the stack of thin layers further comprises a first interlayer IL1 in D2 and/or a second interlayer IL2 in D3,
wherein a position of the first interlayer IL1 is selected from the group consisting of
i. inserted in between and in contact with the contact layer C3 and the first layer comprising the mixed oxide of zinc and tin ZSO1, and
ii. inserted in the first layer comprising the mixed oxide of zinc and tin ZSO1, and
wherein a position of the second interlayer IL2 is selected from the group consisting of
i. inserted in between and in contact with the contact layer C5 and the second layer comprising the mixed oxide of zinc and tin ZSO2, and
ii. inserted in the second layer comprising the mixed oxide of zinc and tin ZSO2.

5: The glazing unit according to claim 4, wherein the first interlayer IL1 and the second interlayer IL2 comprise a material selected from the group consisting of titanium oxide, a mixed oxide of titanium and zirconium, a mixed oxide of nickel and chromium, and a mixed oxide of nickel, chromium and tungsten.

6: The glazing unit according to claim 1, any wherein the zinc oxide-comprising contact layers C1 to C6 comprise a material selected from the group consisting of a zinc oxide doped with aluminium and pure ZnO.

7: The glazing unit according to claim 1, wherein a thickness of D1 is comprised between 30 and 50 nm,
a thickness of D2 is between 65 and 85 nm,
a thickness of D3 is between 50 and 70 nm, and
a thickness of D4 is between 25 and 45 nm.

8: The glazing unit according to claim 1, wherein a thickness of D2 is larger than a thickness of each of D1, D3, and D4 and a thickness of D3 is larger than the thickness of each of D1 and D4.

9: The glazing unit according to claim 1, wherein a ratio of a thickness of D1 to a thickness of D4 is between 0.8 and 1.4.

10: The glazing unit according to claim 1, wherein thicknesses of the three infrared radiation reflecting functional layers Ag1, Ag2 and Ag3 are each between 10 and 16 nm.

11: The glazing unit according to claim 1, wherein a thickness of the first functional layer Ag1 is between 12 and 18 nm,
a thickness of the second functional layer Ag2 is between 10 and 15 nm, and
a thickness of the third functional layer Ag3 is between 12 and 17 nm.

12: The glazing unit according to claim 1, wherein a ratio of a thickness of the first functional layer Ag1 to a thickness of the third functional layer Ag3 is between 0.8 and 1.2.

13: The glazing unit according to claim 1, wherein a thickness of the second functional layer Ag2 is lower than a thickness of each of the first functional layer Ag1 and the third functional layer Ag3.

14: The glazing unit according to claim 1, wherein the metal oxide comprising bottom layer BL is a layer of an oxide of at least one element selected from the group consisting of Zn, Sn, Ti and Zr.

15: The glazing unit according to claim 1, wherein the metal oxide comprising bottom layer BL has a thickness of a least 30 nm and at most 50 nm.

16: The glazing unit according to claim 1, wherein the silicon nitride in the first, second, and third layers comprising silicon nitride is selected from the group consisting of Si3N4 and SiₓN_{y} with an atomic ratio of Si/N from 0.6 to 0.9 and a mixed nitride of silicon and zirconium with a weight ratio of Si/Zr ranging between 70/30 and 50/50.

17: The glazing unit according to claim 1, wherein the first, second, and third layers comprising silicon nitride each have a thickness of at least 15 nm and at most 40 nm.

18: The glazing unit according to claim 1, wherein the first, second, and third layers comprising the mixed oxide of zinc and tin comprise a mixed oxide of zinc and tin having a weight ratio of zinc to tin, Zn/Sn, from 1/9 to 9/1.

19: The glazing unit according to claim 1, wherein the first, second, and third layers comprising the mixed oxide of zinc and tin each have a thickness of at least 10 nm and at most 50 nm.

20: The glazing unit according to claim 1, wherein the top layer comprising the metal oxide or the metal nitride is a layer comprising titanium and/or zirconium or a mixed nitride of silicon and zirconium.
